(19) United States
(12) Patent Application Publication
(10) Pub. No.: US 2023/0171832 A1
(43) Pub. Date: Jun. 1, 2023

(54) APPARATUS AND METHOD THEREOF FOR MANAGING ACCESS NODES FOR LOW-LATENCY SERVICE IN MULTI-RADIO MULTI-CONNECTIVITY NETWORK

(71) Applicant: ELECTRONICS AND TELECOMMUNICATIONS RESEARCH INSTITUTE, Daejeon (KR)

(72) Inventors: Sun Mi JUN, Daejeon (KR); Il Gyu KIM, Daejeon (KR); Jun Sik KIM, Daejeon (KR); Soon Gi PARK, Daejeon (KR); Sung Cheol CHANG, Daejeon (KR); Hee Sang CHUNG, Daejeon (KR); Yong Seouk CHOI, Daejeon (KR)

(73) Assignee: ELECTRONICS AND TELECOMMUNICATIONS RESEARCH INSTITUTE, Daejeon (KR)

(21) Appl. No.: 18/070,677

(22) Filed: Nov. 29, 2022

(30) Foreign Application Priority Data
Nov. 29, 2021 (KR) 10-2021-0167042
Nov. 23, 2022 (KR) 10-2022-0158250

(51) Int. Cl. H04W 76/16; H04W 8/00

(52) U.S. Cl. CPC H04W 76/16; H04W 8/005

(57) ABSTRACT

A apparatus and a method thereof for managing access nodes for a low-latency service in a multi-radio multi-connectivity network are proposed. The method of operating user equipment (UE) in a wireless communication system includes a process of scanning a plurality of secondary nodes (SNs) where radio signals are measured around the UE, a process of transmitting a scanning result to a master node (MN), a process of receiving information about an SN group from the MN, a process of accessing an active SN on the basis of the information about the SN group, and a process of transmitting a message for establishing and modifying a protocol data unit (PDU) session to a core network (CN).

### CROSS REFERENCE TO RELATED APPLICATION

The present application claims priority to Korean Patent Application No. 10-2022-0158250, filed Nov. 23, 2022, and Korean Patent Application No. 10-2021-0167042, filed Nov. 29, 2022, the entire contents of which is incorporated herein for all purposes by this reference.

### BACKGROUND OF THE INVENTION

### Field of the Invention

The present disclosure relates to a wireless communication system in general and, more particularly, to an apparatus and a method thereof for managing access nodes for a low-latency service in a multi-radio multi-connectivity network in a wireless communication system.

### Description of the Related Art

An objective of 6G service, which should provide services in sub-terahertz bands, is to ensure 99.9% reliability, low-latency performance within 1 ms end-to-end, and low-latency performance within 0.4 ms in wireless sections.

Sub-terahertz bands in the 0.1 THz to 0.3 THz domain provide high data transmission rates, but due to physical limitations (i.e., free-space attenuation, molecular absorption loss, and NLOS path loss) of the wireless bands, data loss rates are high and extremely small coverage areas are supported.

In addition, in a sub-terahertz network, an ultra-compact small cell structure having a complex coverage design is required, multiple access to Sub-6 Hz, mmWave, and Sub-THz should be possible, the Sub-6 Hz, which supports a widest coverage, is operated for a macro node, and the mmWave and Sub-THz bands, which provide small coverages and are relatively unstable in a wireless communication environment, are operated for secondary nodes.

### SUMMARY OF THE INVENTION

Based on the discussion described in detail, the present disclosure provides an apparatus and a method thereof for ensuring user mobility and service continuity in multi-bands including a sub-terahertz wireless domain in a wireless communication system.

In addition, the present disclosure provides an apparatus and a method thereof for providing high-reliability low-latency transmission in a wireless communication system.

In addition, the present disclosure provides an apparatus and a method thereof for configuring an ultra-dense network capable of multi-radio multi-connectivity in a wireless communication system.

In addition, the present disclosure provides an apparatus and a method thereof for reducing signaling overhead, due to user movement, according to an ultra-dense network configuration in a wireless communication system.

According to various exemplary embodiments of the present disclosure, there is provided a method of operating user equipment (UE) in a wireless communication system, the method including: a process of scanning a plurality of secondary nodes (SNs) where radio signals are measured around the UE; a process of transmitting a scanning result to a master node (MN); a process of receiving information about an SN group from the MN; a process of accessing an active SN on the basis of the information about the SN group; and a process of transmitting a message for establishing and modifying a protocol data unit (PDU) session to a core network (CN).

According to various exemplary embodiments of the present disclosure, there is provided a method of operating a master node (MN) in a wireless communication system, the method including: a process of receiving a scanning result for a plurality of secondary nodes (SNs) from user equipment (UE); a process of configuring an SN group on the basis of the scanning result; a process of transmitting information about the SN group to the UE; a process of receiving a message for notifying completion of establishing and modifying a PDU session from a core network (CN); and a process of changing an active SN on the basis of the message.

According to various exemplary embodiments of the present disclosure, there is provided with a method of a core network (CN), the method including: a process of receiving a message for establishing and modifying a PDU session from user equipment (UE); a process of establishing a user plane (UP) path between an active secondary node (SN) and the CN on the basis of the message; a process of establishing a user plane (UP) path between an inactive secondary node (SN) and the CN on the basis of the message; and a process of transmitting a message for notifying the UE of completion of establishing and modifying the PDU session.

The apparatus and the method thereof according to various exemplary embodiments of the present disclosure ensure a large-capacity multimedia service and user mobility in the multi-radio multi-connectivity network, so that low latency is secured in a system requiring frequent secondary node changes depending on user movement paths, thereby ensuring the large-capacity multimedia service and the user mobility.

The effects of the present disclosure are not limited to the above-mentioned effects, and other different effects that are not mentioned will be clearly understood by those skilled in the art from the following description.

### BRIEF DESCRIPTION OF THE DRAWINGS

FIG. 1 is a view illustrating a wireless communication system according to various exemplary embodiments of the present disclosure.

FIG. 2A is a view illustrating the wireless communication system including an SN group according to various exemplary embodiments of the present disclosure.

FIG. 2B is a view illustrating an example of a service to which the wireless communication system including the SN group according to various exemplary embodiments of the present disclosure is applied.

FIG. 3 illustrates a signal flow diagram between a terminal, an MN, SNs, a UPF, and an AMF/SMF according to various exemplary embodiments of the present disclosure.

FIG. 4 illustrates a signal flow diagram between a terminal, an MN, SNs, a UPF, and an AMF/SMF according to an exemplary embodiment of the present disclosure.

FIG. 5 illustrates a signal flow diagram for a handover operation by UE from a serving SN to a target SN according to exemplary embodiments of the present disclosure.

FIG. 6 illustrates a signal flow diagram for selecting an SN from an SN group in the wireless communication system according to various exemplary embodiments of the present disclosure.

FIG. 7 illustrates a signal flow diagram between UE, nodes, and a core network for changing an SN group according to the exemplary embodiments of the present disclosure.

FIG. 8 illustrates a signal flow diagram between UE, a node, and a core network for changing an SN group according to the exemplary embodiments of the present disclosure.

FIG. 9 illustrates a signal flow diagram for a handover operation by UE from a serving SN to a target SN according to the exemplary embodiments of the present disclosure.

FIG. 10 illustrates a signal flow diagram for creating a UP tunnel between an SN and a core network in an arrangement where only a UP is connected between the SN and the core network according to the exemplary embodiments of the present disclosure.

FIG. 11 a view illustrating a method of operating a terminal in a wireless communication system according to the exemplary embodiments of the present disclosure.

FIG. 12 a view illustrating a method of operating a master node in the wireless communication system according to the exemplary embodiments of the present disclosure.

FIG. 13 a view illustrating a method of operating a core network in the wireless communication system according to the exemplary embodiments of the present disclosure.

FIG. 14 is a view illustrating a configuration of an access node in the wireless communication system according to various exemplary embodiments of the present disclosure.

FIG. 15 is the view illustrating the configuration of a terminal in the wireless communication system according to various exemplary embodiments of the present disclosure.

### DETAILED DESCRIPTION OF THE INVENTION

The terms used in the present disclosure are only used to describe a specific exemplary embodiment, and may not be intended to limit the scope of other exemplary embodiments. As used herein, the singular forms may include the plural forms as well, unless the context clearly indicates otherwise. The terms including technical and scientific terms used herein have the same meaning as commonly understood by one of those skilled in the art described in the present disclosure. Among the terms used in the present disclosure, terms defined in a general dictionary may be interpreted as having the same or similar meaning as the meaning in the context of the related art, and are not interpreted in an ideal or excessively formal meaning unless explicitly defined in the present disclosure. In some cases, even the tams defined in the present disclosure cannot be interpreted to exclude exemplary embodiments of the present disclosure.

In various exemplary embodiments of the present disclosure described below, a hardware approach method is described as an example. However, since various exemplary embodiments of the present disclosure include technology using both hardware and software, various exemplary embodiments of the present disclosure do not exclude a software-based approach method.

Hereinafter, the present disclosure relates to an apparatus and a method thereof for managing access nodes for a low-latency service in a multi-radio multi-connectivity network in a wireless communication system. Specifically, the present disclosure describes a technique for ensuring user mobility and service continuity in a sub-terahertz wireless domain in the wireless communication system.

In the following description, terms referring to signals, terms referring to channels, terms referring to control information, terms referring to network entities, terms referring to components of a device, and the like are illustrated for convenience of the description. Accordingly, the present disclosure is not limited to the terms described below, but other terms having equivalent technical meanings may be used.

In addition, the present disclosure describes various exemplary embodiments by using terms used in some communication standards (e.g., 3rd Generation Partnership Project (3GPP)), but this is only an example for description. Various exemplary embodiments of the present disclosure may be easily modified and applied to other communication systems.

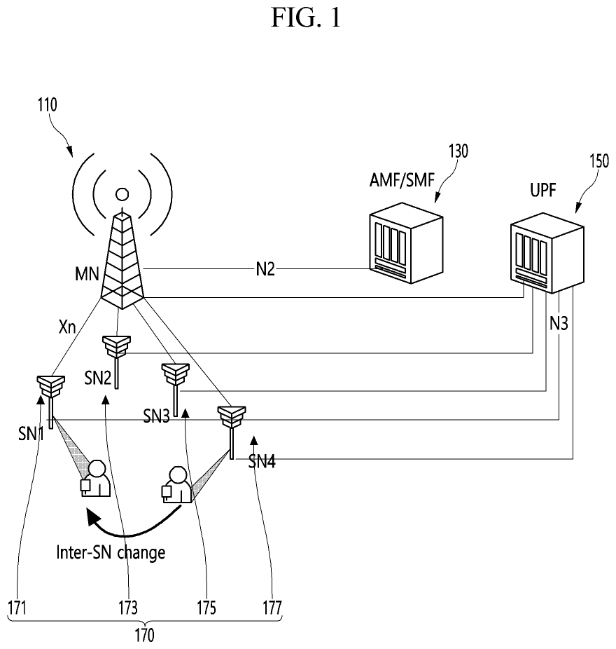

FIG. 1 is a view illustrating a wireless communication system according to various exemplary embodiments of the present disclosure.

FIG. 1 illustrates a master node (MN) 110 as a part of nodes using a wireless channel in a wireless communication system, an access and mobility management function (AMF)/session management function (SMF) 130 and a user plane function (UPF) 150, which are for a core network, and a plurality of secondary nodes (SNs) 170. FIG. 1 illustrates that SNs may include an SN1 171, an SN2 173, an SN3 175, and an SN4 177, but this is only an example and more secondary nodes may be included therein.

Referring to FIG. 1, the MN 110 may be connected to the AMF/SMF 130 through an N2 interface, and may be connected to the UPF 150 through an N3 interface. The MN 110 may be connected to SNs 170 through respective Xn interfaces. The SNs 170 may be connected to the UPF 150 through respective N3 interfaces.

Referring to FIG. 1, the wireless communication system of FIG. 1 may be a multi-radio multi-connectivity (MR-MC) network that users are able to access simultaneously. In the case of MR-MC, the MN 110 may be allocated with a frequency band with high stability in a multi-radio environment, and the SNs 170 may be allocated with a band with a high data transmission rate. For example, a Sub-6 Ghz band may be established for the MN, and mmWave and Sub-THz bands may be established for the SNs.

In the case of the MR-MC network, handover in SNs may occur frequently depending on user movement. In this case, since coverage is very narrow in a high-frequency domain such as a Sub-THz domain, handover to another access node may occur more frequently when out of coverage. As an example, FIG. 1 illustrates a case in which a user is handed over from an SN4 177 to an SN1 171.

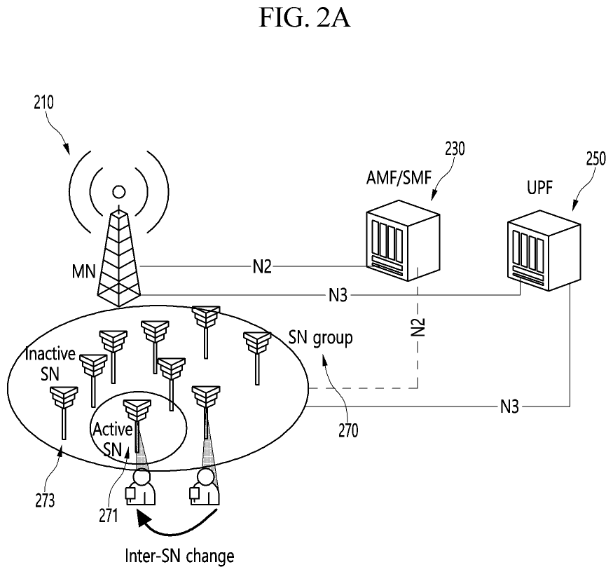

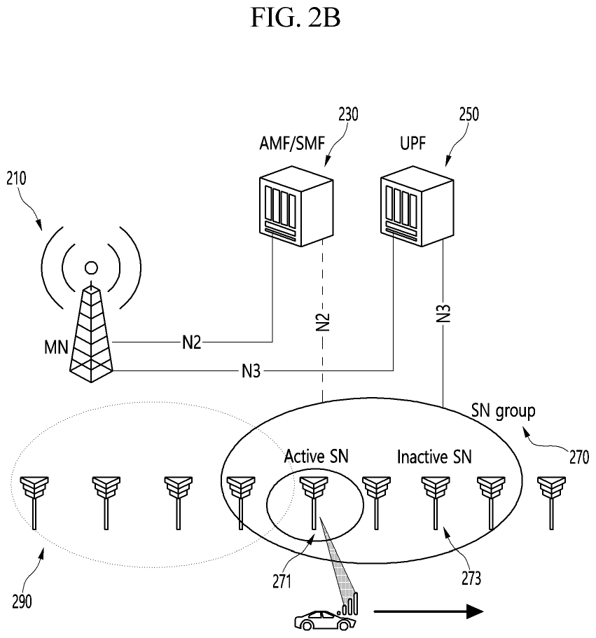

FIG. 2A is a view illustrating the wireless communication system including an SN group according to various exemplary embodiments of the present disclosure. An MN 210, an AMF/SMF 230, and a UPF 250 of FIGS. 2A and 2B may have the same configuration as the MN 110, the AMF/SMF 130, and the UPF 150 shown in FIG. 1.

FIG. 2A illustrates the wireless communication system, which includes the SN group, as a wireless communication system for maximally reducing latency occurred due to handover disclosed in FIG. 1. The SN group may refer to an SN group including not only a secondary node to which a user is connected but also nodes to be connected in the future. Hereinafter, in the present disclosure, a node to which a user is connected may be referred to as an active node, and nodes that are not yet connected but to be connected may be referred to as inactive nodes.

Referring to FIG. 2A, unlike FIG. 1, in FIG. 2A, the AMF/SMF 230 and the SN group 270 may be connected to each other by an N2 interface. Accordingly, as shown in FIG. 2A, in the present disclosure, information of not only an active node but also inactive nodes is shared in the MN 210 and the core network (CN) through the wireless communication network in advance, so that a delay caused change control signals, generated depending on user movement, to a serving secondary access node and a target secondary access node, may be reduced.

FIG. 2B is a view illustrating an example of a service to which the wireless communication system including the SN group according to various exemplary embodiments of the present disclosure is applied.

Referring to FIG. 2B, the wireless communication system shown in FIG. 2B may reorganize an SN group 270 according to a user's moving path, and may generate a ready state where SNs 271 and 273 constituting the SN group 270 receive services by establishing respective Xn interfaces, an N2 interface, and an N3 interface, regardless of whether a wireless connection with a user exists or not. Accordingly, high-capacity, low-latency services may be continuously provided even in high-frequency bands of Sub-THz and mmWave.

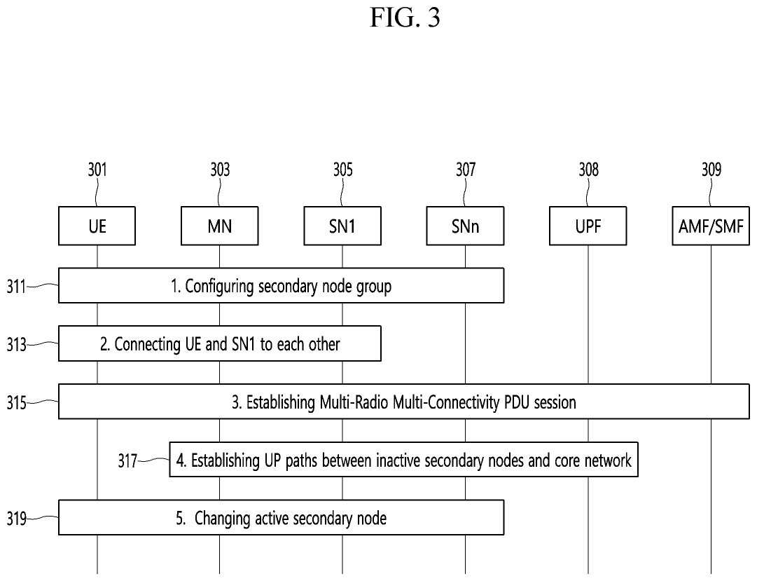

FIG. 3 illustrates a signal flow diagram between a terminal, an MN, SNs, a UPF, and an AMF/SMF according to various exemplary embodiments of the present disclosure. FIG. 3 illustrates a signal flow diagram depicted so that UE 301 capable of MR-MC connects to an MN 303 and an SN1 305 at the same time, configures an SN1 305 and reserve SNs (i.e., SN2, . . . , SNn) as a group, and sets the reserve SNs (SN2, . . . , SNn) to be in an inactive state. In FIG. 3, the SN1 305 may be an active node and each of the SN2, . . . , SNn may be an inactive node.

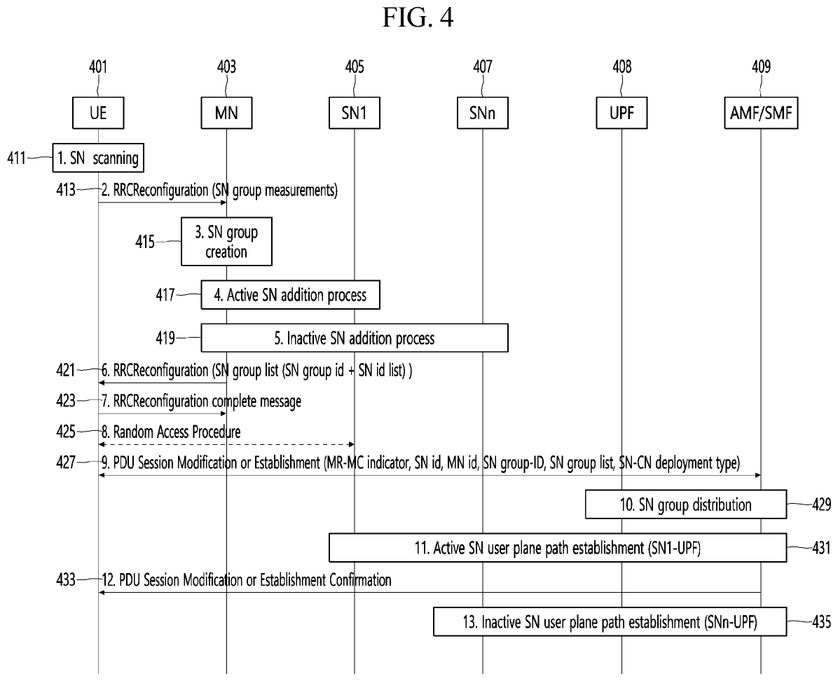

Referring to FIG. 3, in operation 311, user equipment (UE) 301, an MN 303, and SNs 305 and 307 may create a secondary node group of SN2, . . . , SNn. For example, the UE 301 may scan a plurality of SNs capable of detecting radio signals and report a scanning result to the MN 303, and thereafter, the MN 303 may create the secondary node group. Specific operations for operation 311 may correspond to operations 411 to 423 of FIG. 4.

In operation 313, the UE 301 may connect to the SN1 305. For example, the UE 301 may perform a radio resource control (RRC) access (e.g., a random access procedure) with the active secondary node SN1 305 in the secondary node group information provided by the MN 303. Operation 313 may correspond to operation 425 of FIG. 4.

In operation 315, the UE 301 may establish and modify an MR-MC protocol data unit (PDU) session. Operation 315 may correspond to operations 427 to 433 of FIG. 4.

In operation 317, the MN 303 may establish user plane (UP) paths between the inactive secondary nodes SN2, . . . , SNn and the core network. Specifically, without connecting to the UE 301, the MN 303 may establish data paths (i.e., N3 tunnels with the UPF) between the core network and the plurality of inactive secondary SNs (SN2, . . . , SNn) added to the SN group. Operation 317 may correspond to operation 435 of FIG. 4.

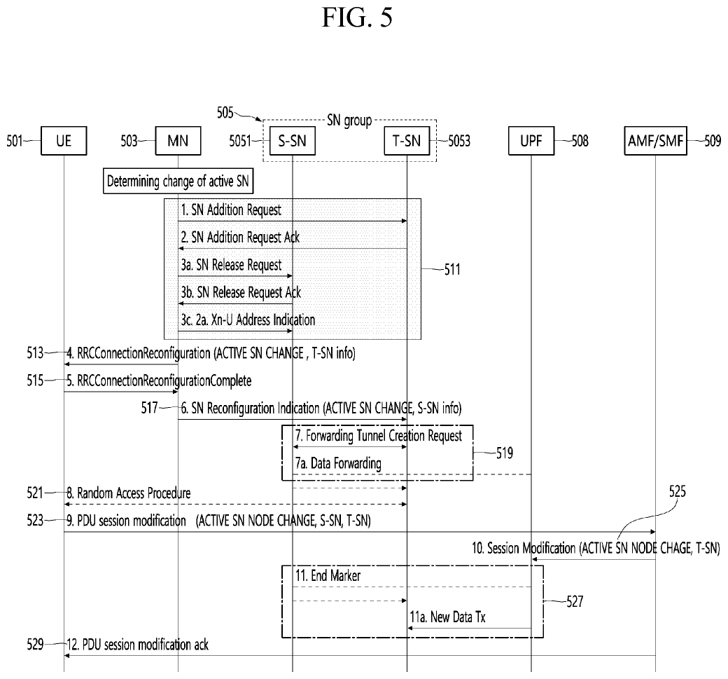

In operation 319, the UE 301 may perform an operation for changing the active secondary node from an SN1 405 to an SNn 407. Operation 319 may correspond to operations 511 to 529 of FIG. 5.

FIG. 4 illustrates a signal flow diagram between a terminal, an MN, SNs, a UPF, and an AMF/SMF according to an exemplary embodiment of the present disclosure.

Referring to FIG. 4, in operation 411, UE 401 may scan neighboring SNs.

In operation 413, the UE 401 may report a result of scanning the neighboring SNs to an MN 403 through RRCReconfiguration message. According to the exemplary embodiment, the scanning result of operation 413 may be reported periodically. According to the exemplary embodiment, the scanning result of operation 411 may include SN identifiers for the detected SNs and radio signal measurement values.

According to another exemplary embodiment, when the MN 403 transmits an SN group measurement request to the UE 401, the UE 401 may transmit the scanning result of operation 411 to the MN 403 through RRCReconfiguration message.

In operation 415, the MN 403 may create an SN group. Specifically, the MN 403 may select a plurality of candidate SNs that may be connected to the UE 401 on the basis of the scanning result of the UE 401, so as to form the candidate SNs into an SN group, thereby managing the SN group by assigning an SN group ID as an identifier to the SN group. In addition, the MN 403 may select the SN1 405 predicted to have good connectivity among the SNs in the SN group and designate the SN1 405 as an active secondary node. Other scanned nodes may be designated as inactive secondary nodes SN2, . . . , SNn.

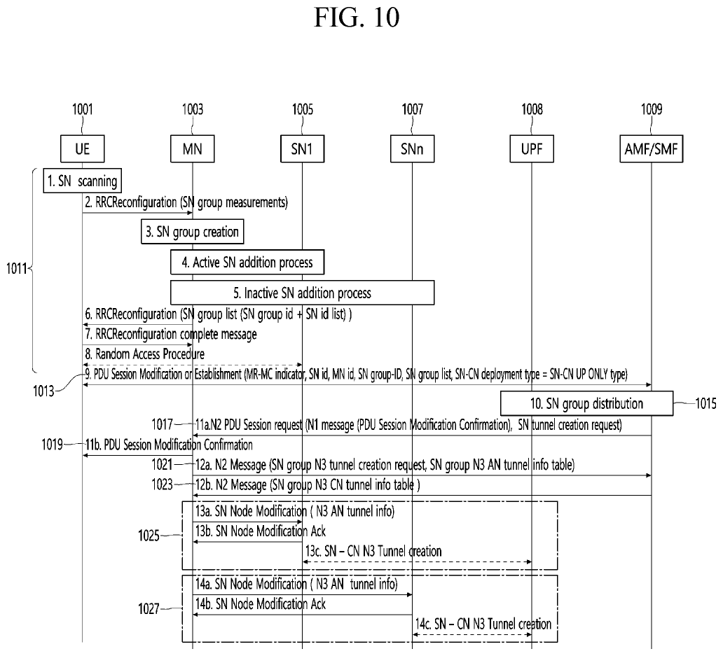

In operation 417, the MN 403 may perform an SN addition procedure with the active secondary node SN1 405. A signaling procedure may follow steps 1 to 2a of FIG. 10.2.2-1 in 3GPP specification TS 37.340.

In operation 419, the MN 403 may perform the SN addition procedure with a plurality of inactive secondary nodes. The signaling procedure between the MN and the inactive secondary nodes may follow steps 1 to 2a of FIG. 10.2.2-1 in 3GPP specification TS 37.340. According to the exemplary embodiment, wireless connection between the inactive secondary nodes and the UE 401 is not performed.

In operation 421, the MN 403 may transmit group information of the active SN and inactive SNs to the UE 401 through RRCReconfiguration message. According to the exemplary embodiment, in operation 421, the SN group information may include an SN group ID and an SN ID list of SNs constituting an SN group.

Corresponding to operation 421, in operation 423, the UE 401 may transmit a message, corresponding to the message of operation 421, to the MN 403 through RRCReconfiguration completion message.

Operations 411 to 423 may be operations that embody operation 311 of FIG. 3.

In operation 425, the UE 401 may be connected to the active secondary node SN1 405 through the random access procedure.

In operation 427, the UE 401 may transmit information on inactive secondary nodes for establishing and modifying a PDU session to the core network. According to the exemplary embodiment, the information on the inactive secondary nodes for establishing and modifying the PDU session may include information on the MN 403, the active secondary node SN1 405, and the inactive secondary nodes. According to the exemplary embodiment, the core network may include an AMF/SMF 409.

In addition, since inactive secondary nodes are not currently wirelessly connected to the UE 401 but may potentially be connected to the UE 401, a user data path with the core network should be established in advance. To this end, according to the exemplary embodiment, the information on the inactive secondary nodes may include information on the inactive SNs, the information being inactive SN information in which the UE 401 has MR-MC connections simultaneously connected to the MN 403 and the secondary nodes and the user data path should be established in advance. According to the exemplary embodiment, the information on the inactive secondary nodes may be included in a PDU Session Establishment request message and a PDU Session Modification request message of 3GPP TS 23.502. According to the exemplary embodiment, the message including the information on the inactive secondary nodes may include parameters such as an MR-MC indicator, SN identifiers, an MN identifier, an SN group identifier, an SN group list, and an SN-CN deployment type. Subsequent procedures for a subsequent PDU session establishment request (or a modification request) may be the same as those procedures in Section 4.3.2 of TS 23.502.

The MR-MC indicator may be a parameter in which the UE 401 informs the core network (e.g., the AMF/SMF 409) that the PDU session is an MR-MC connection and that SN group management is required. The core network may receive the MR-MC indicator and perform the SN group management.

The SN identifiers are secondary node identifiers, and the MN identifier is a master node identifier. Those identifiers may be shared and identified in the UE, MN, SNs, and core network.

The SN group is a set of SNs that are generated by the MN 403 in operation 411. The SN group may be handed over by the UE 401. Also, information of the SN group may be transmitted to the core network along with the SN group id in operation 415.

The SN-CN deployment type may indicate deployment types of the SNs and CN. In 3GPP specification, both a user plane (UP) (in an N3 interface) and a control plane (CP) (in an N2 interface) are allowed for interfaces between the MN and the core network, but only the UP may be accepted for the deployment type between the secondary access nodes and the core network.

According to the exemplary embodiment, when an SN-CN deployment type is SN-CN UP only, a UP interface N3 between the SNs and CN may be provided and there may be no CP interface. According to another exemplary embodiment, when an SN-CN deployment type is SN-CN UP with CP, the SNs and CN may have a CP interface N2 and a UP interface N3. Operation in a case of the SN-CN deployment type with SN-CN UP only is illustrated in detail in FIG. 10.

In operation 429, in the core network, SN group information may be distributed to functional entities (i.e., the SMF and UPF) that should establish respective data paths with SNs. According to the exemplary embodiment, the core network may manage the SN group information for each PDU session. The SN group information may include a PDU session identifier, an MN identifier, an active SN identifier, an SN group identifier, and an SN group list.

In operation 431, when the SN-CN deployment type of operation 427 is SN-CN UP with CP, an N3 tunnel for data transmission between a UPF 408 and the active SN (SN1) 405 may be created. The SN1 405 may transfer tunnel creation information (e.g., one exemplary embodiment: AN tunnel info, CN tunnel info) to the MN 403 and then complete a subsequent PDU session establishment or modification procedure. According to the exemplary embodiment, operation 431 is performed between the CN and the active SN, which is SN1 405, and may be the same as steps 10a to 12 and 14 of FIG. 4.3.2.2.1-1 of TS 23.502. Operations 427 to 431 of FIG. 4 may be operations that embody operation 315 of FIG. 3.

In operation 433, a AMF/SMF 409 may transmit a PDU Session Modification or Establishment Confirmation message to the UE 401 in order to complete the PDU session establishment or modification procedure. According to the exemplary embodiment, operation 433 may be the same as the procedure of section 4.3.2 (or section 4.3.3) of TS 23.502.

In operation 435, a plurality of inactive SNs (SN2, . . . , SNn), added to the SN group, without connecting to the UE may perform establishment of a data path with the core network (i.e., an N3 tunnel to the UPF 408). Operation 435 is performed between the CN and the SNn that are the inactive SNs, and may be the same as steps 10a to 12 and 14 of FIG. 4.3.2.2.1-1 of TS 23.502.

FIG. 5 illustrates a signal flow diagram for a handover operation by UE from a serving SN to a target SN according to exemplary embodiments of the present disclosure. FIG. 5 embodies operation 319 of FIG. 3 and illustrates the operation of a signal for initiating a change of an active SN by UE 501.

Referring to FIG. 5, when the target SN does not exist in the same SN group as that of the serving SN, operation 511 may be performed. According to the exemplary embodiment, operation 511 may correspond to steps 1 to 3 of FIG. 10.5.2.-1 of an MN initiated SN change procedure of section 10.5.2 in TS 37.340. When the target SN belongs to the same SN group as that of the serving SN and a traffic path has already been established with the core network in advance, an SN change procedure may be performed starting from operation 513.

In operation 513, when the SN change is performed by an MN 503, the MN 503 may transmit the active SN change indicator and T-SN information to the UE 501 by including them in RRC Reconfiguration message.

In operation 515, the UE 501 may transmit RRC Reconfiguration completion message to the MN 503.

When the MN 503 receives RRC Reconfiguration completion from the UE 501, the MN 503 may transmit SN Reconfiguration indication message including an ACTIVE SN CHANGE Indicator and S-SN info (information) to a T-SN 5053. According to the exemplary embodiment, the S-SN info may include a PDU session ID, an S-SN ID, serving AN tunnel info (information), and serving CN tunnel info (information).

In operation 519, a forwarding tunnel is created between the S-SN 5051 and the T-SN 5053, and until a connection between the UE 501 and the T-SN 5053 is completed, the S-SN 5051 may forward the received data to the T-SN 5053.

In operation 521, the UE 501 and the T-SN 5053 may be connected to each other through a random access procedure.

In operation 523, the UE 501 may transmit a PDU Session Modification message to notify the change of the active secondary node to the AMF/SMF 509 of the core network. The PDU Session Modification message may include an active SN change indicator, an S-SN id, a T-SN id, an MN id, and SN group id information.

In operation 525, the AMF/SMF 509 may transmit a Session Modification message (e.g., one exemplary embodiment: N4 session modification Request) to the UPF 508 in order to request the change of the active secondary node of the SN group. The Session Modification message may include an ACTIVE SN NODE CHANGE indicator and T-SN information. By transmitting the Session Modification message, a bearer may be changed according to the change of the active secondary node of the SN group.

According to the exemplary embodiment, operation 527 may correspond to steps 13 to 15 of FIG. 10.5.2-1 of section 10.5.2 of TS 37.340.

In operation 529, the AMF/SMF 509 may transmit a PDU Session modification ack (acknowledgement) message to the UE 501.

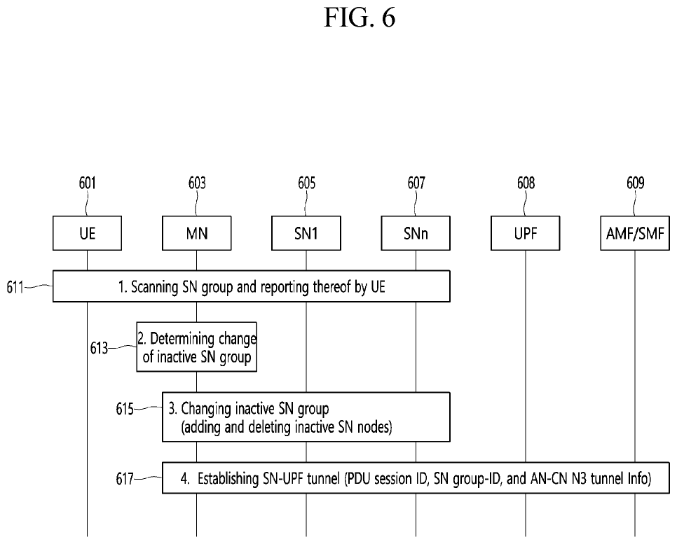

FIG. 6 illustrates a signal flow diagram for selecting an SN from an SN group in the wireless communication system according to various exemplary embodiments of the present disclosure. FIG. 6 relates to an inactive SN management function, and illustrates a signal flow diagram between UE, nodes, and a core network, wherein even in a situation where an SN group is already configured, the UE accessed via MR-MC selects SNs that may be accessed in the future while receiving a service, so as to add the SNs as inactive nodes of the SN group or delete SNs, which are unlikely to be accessed, from the SN group.

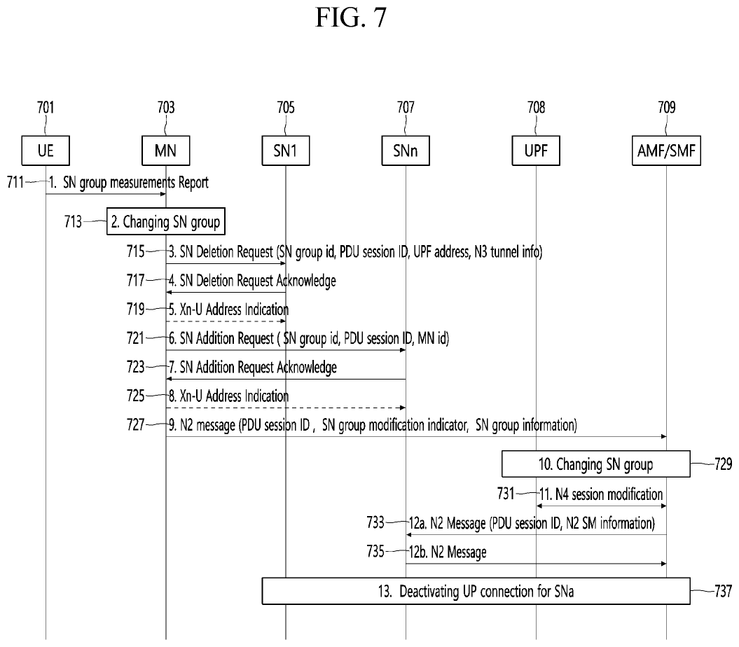

Referring to FIG. 6, in operation 611, UE 601 may scan a plurality of SNs for which radio signals are measured and periodically report a scanning result to an MN 603, or may transfer the scanning result to the MN 603 when requested by the MN 603. Operation 611 may correspond to operation 711 of FIG. 7.

In operation 613, the MN 603 may determine a change of the inactive SN group.

In operation 615, the MN 603 may collect radio signals of neighboring SNs around the UE 601 and change the active SN to an SN with a better radio state. According to the exemplary embodiment, by collecting the radio signals of the neighboring SNs around the UE 601, without changing the active SN having a better radio condition, the MN 603 may insert inactive SNs into the SN group, or remove the existing inactive SNs. Operations 603 and 605 may correspond to operations 713 to 727 of FIG. 7.

In operation 617, the MN 603 may change the changed inactive SNs and a UPF user data tunnel. Operation 617 may correspond to operations 729 to 737 of FIG. 7.

FIG. 7 illustrates a signal flow diagram between UE, nodes, and a core network for changing an SN group according to the exemplary embodiments of the present disclosure. FIG. 7 is the signal flow diagram for changing, as a procedure initiated by the MN, a UP connection path with the core network according to changing of SNs inserted into or removed from the SN group.

In operation 711, according to setting a UE measurement procedure with an MN 703, UE 701 may periodically perform reporting of radio signal scanning measurement of the SNs constituting the SN group, or respond whenever requested. Operation 711 may be an operation that embodies operation 611 of FIG. 6.

In operation 713, the MN 703 may determine a change of an SN group.

In operation 715, the MN 703 may transmit an SN Deletion Request including an SN group identifier, a PDU session identifier, a UPF address, and N3 tunnel information to an SNa 705 in order to delete the removed SNa node 705 from the group.

In operation 717, when the MN 703 receives the SN Deletion Request in response to operation 715, the MN 703 may transmit an SN Deletion Request Acknowledge message to complete information change of the SN group.

In operation 719, when data forwarding between access nodes is executable, the MN 703 may transmit forwarding address information to the SNa 705 by transmitting an Xn-U address indication message.

The MN 703 may transmit an SN addition Request message in order to add an inserted SNb node to the group. According to the exemplary embodiment, in operation 721, the SN addition request may include an SN group identifier, a PDU session identifier, a UPF address, and an MN identifier.

A SNb 707 may transmit an SN addition Request Ack in response to operation 721. In operation 723, upon receiving this signal, the MN 703 may complete the information change of the SN group.

In operation 725, when the data forwarding between the access nodes is executable, the MN 703 may provide the forwarding address information to the SNb 707.

In operation 727, the MN 701 may transmit an N2 control message in order to inform a core network (e.g., an AMF/SMF 709) of the change of SN group members. According to the exemplary embodiment, the N2 control message may include a PDU session identifier, an SN group modification indicator, and the changed SN group information. The SN group modification indicator may refer to an indicator for notifying that the configuration of the SN group is modified in the core network. In the SN group information, information about insertion of SNb 707 and removal of SNa 705 may be included. Operations 713 to 727 may be operations that embody operations 613 and 615 of FIG. 6.

In operation 729, the SMF 709 may change the information of the removed node and the inserted node in the existing SN group stored in the SMF 709 and UPF 708 according to the configuration change of the SN group.

In operation 731, a change of N4 session between the UPF and the SMF 709 may be performed. Specifically, when CN tunnel info for an N3 interface between the UPF 708 and the SNb 707 is not assigned, the CN tunnel info may be newly assigned. The N4 session modification and establishment procedure may be the same as that in TS 23.502.

The AMF/SMF 709 may transmit an N2 message to the SNb 707. According to the exemplary embodiment, the N2 message may include a PDU session ID and N2 SM information. In operation 733, the N2 SM information may include a PDU session ID, QFI(s), a PDU session type, and CN tunnel info.

In operation 735, the SNb 707 may receive the N2 message in operation 733, assign AN tunnel info for the PDU session after analyzing the N2 SM information, include the N2 SM information in the N2 message, and then transmit the N2 message to the AMF 709.

In operation 737, the SMF 709 may deactivate the UP connection with the core network for the SNa 705. The procedure of operation 737 may correspond to steps 4a to 9 of FIG. 4.3.7-1 of section 4.3.2 of TS 23.502.

Operations 729 to 737 may be operations that embody operation 617.

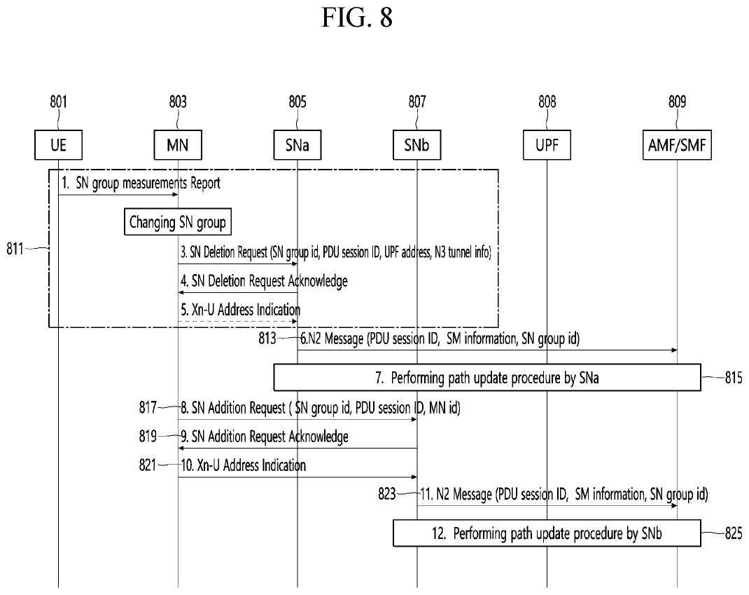

FIG. 8 illustrates a signal flow diagram between UE, a node, and a core network for changing an SN group according to the exemplary embodiments of the present disclosure. FIG. 8 is a signal flow diagram for changing, as a procedure initiated by SNs, a UP connection path with the core network according to a change of SNs inserted into or removed from a SN group.

Referring to FIG. 8, since operation 811 may be the same as operations 711 to 719 of FIG. 7 and specific details are the same as those of operations 711 to 719 of FIG. 7, the specific details may be omitted.

In operation 813, in order to notify removal from the SN group members, an SNa 805 may transmit an N2 message to a core network (e.g., an AMF/SMF 809). According to the exemplary embodiment, the N2 message may include a PDU session identifier, an SN group id, an inactive SN deletion indicator, and SM information. The inactive SN detection indicator may be an indicator for notifying that an SNb 807 is removed from a SN group. The SN information may include AN tunnel info and CN tunnel info.

In operation 815, the SNa 805 may release a UP connection path between the SNb 807 and the core network. Operation 815 may be described by FIG. 4.3.7-1 of section 4.3.2 of 3GPP TS 23.502.

In operation 817, an MN 803 may transmit an SN Addition Request message in order to add the inserted SNb 807 node into the group. According to the exemplary embodiment, the SN Addition Request message may include an SN group identifier, a PDU session identifier, a UPF address, and an MN identifier.

In operation 819, when the MN 803 receives the SN Addition Request Ack in response to operation 817, the MN 803 may complete the information change of the SN group.

In operation 821, when data forwarding between access nodes is executable, the MN 803 may transmit forwarding address information to an SN.

In operation 823, the SNb 807 may transmit an N2 message to the core network in order to notify the core network of insertion of the SN group member. According to the exemplary embodiment, the N2 message may include a PDU session identifier, an SN group id, an inactive SN addition indicator, and SM information. The SNb 807 may allocate an AN tunnel for a UP path between the SNb 807 and the core network. The SN information may include AN tunnel info. The inactive SN addition indicator may be an indicator for notifying that SNa 805 is inserted into the SN group.

In operation 825, the SNb 807 may establish the UP connection path between the SNb 807 and the core network. Operation 825 may be described by FIG. 4.3.7-1 of section 4.3.2 of 3GPP TS 23.502.

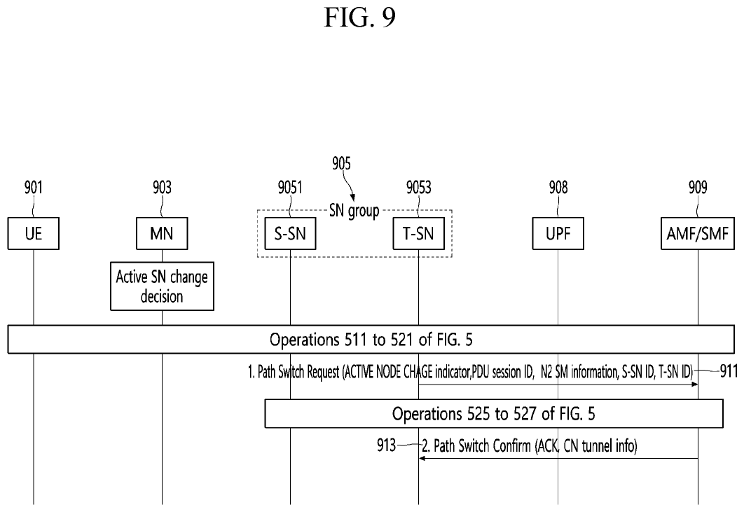

FIG. 9 illustrates a signal flow diagram for a handover operation by UE from a serving SN to a target SN according to the exemplary embodiments of the present disclosure. FIG. 9 illustrates operation of a signal to initiate changing an active SN by an access node (AN).

Referring to FIG. 9, a T-SN 9053 may transmit a path switch request to an AMF 909. According to the exemplary embodiment, the path switch request may include an ACTIVE NODE CHANGE indicator, a PDU session ID, N2 SM information, an S-SN ID, and a T-SN ID.

The AMF 909 may transmit Path switch confirm in order to inform that the path change from an S-SN 9051 to the T-SN 9053 has been completed. According to the exemplary embodiment, the Path switch confirm may include ACK or NACK, and CN tunnel info.

FIG. 10 illustrates a signal flow diagram for creating a UP tunnel between an SN and a core network in an arrangement where only a UP is connected between the SN and the core network according to the exemplary embodiments of the present disclosure. FIG. 10 illustrates exchange of control messages with the core network with the help of an MN in order to create a UP tunnel between the SN and the core network in a case where only the UP is connected and a CP is not connected between the SN and the core network.

Referring to FIG. 10, operation 1011 is the same as operations 411 to 425 of FIG. 4, and thus detailed descriptions thereof may be omitted.

In operation 1013, UE 1001 may transmit an N1 message to the core network. According to the exemplary embodiment, the N1 message may be a PDU Session Establishment or Modification request. According to the exemplary embodiment, the N1 message may include an SN-CN deployment type, which is set to an SN-CN UP ONLY type.

Operation 1015 may be the same operation as operation 729 of FIG. 7.

In operation 1017, a core network (e.g., an AMF/SMF 1009) may transmit an N2 PDU Session request including the N1 message in order to correspond to the N1 message of operation 1013. According to the exemplary embodiment, the N2 PDU session request message may include an SN Tunnel creation request in order to request an MN to create an N3 UP tunnel for SNs.

In operation 1019, the MN 1003 may transmit a PDU Session Modification Confirmation message to the UE 1001. PDU Session Modification Confirmation may be a message corresponding to the message of operation 1013. In addition, an N1 container responding to the message of operation 1013 included in the message of operation 1017 may be transferred. Operation 1019 may be the same as that of 3GPP TS 23.502.

In operation 1021, the MN 1003 may transmit an N2 message to the core network in order to request creation of an N3 UP tunnel between the SNs constituting an SN group and a UPF 1008 of the core network. According to the exemplary embodiment, the N2 message may include an SN group N3 tunnel creation request and an SN group AN tunnel info table.

The SN group AN tunnel info table may be a set of AN tunnel identifiers for identifying respective N3 tunnels for SN1, . . . , SNn. In the procedures 4 and 5 of operation 1011, the SNs assign the AN tunnel identifiers and deliver the AN tunnel identifiers to the MN 1003. The MN 1003 may compose an SN group AN tunnel info table. In addition, the SN group AN tunnel info table may be included in the message of operation 1021.

In operation 1023, a core network (e.g., an AMF/SMF 1009) may transmit an N2 message including SN group CN Tunnel info to the MN 1003. That is, when the core network receives an SN group N3 tunnel creation request, AN tunnel identifiers and corresponding CN tunnel identifiers may be assigned to create respective N3 tunnels of the SNs specified in the SN group AN tunnel info table.

In operation 1025, the MN 1003 may transmit an SN Node Modification message including information on the N3 CN tunnel allocated by the core network to an SN1 1005 included in the SN group. After operation 1025, an N3 tunnel between the SN1 1005 and the core network is created to transmit data.

After that, operation 1025 may be performed for each SN to transmit an SN Node Modification message to each SN, included in the SN group, in addition to the SN1 1005. Operation 1027 illustrates an operation of transmitting the SN Node Modification message for SNn.

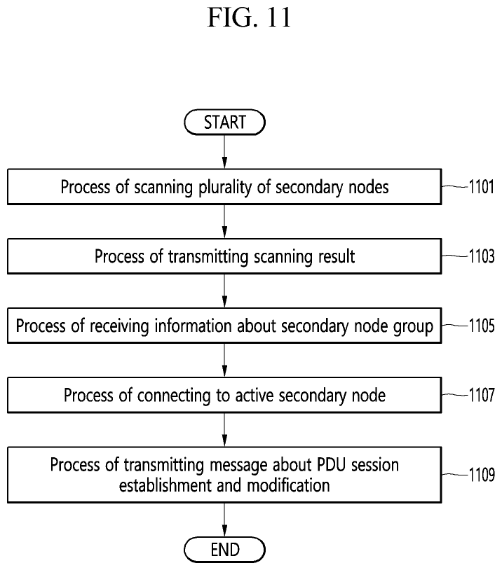

FIG. 11 a view illustrating a method of operating a terminal in a wireless communication system according to the exemplary embodiments of the present disclosure.

Referring to FIG. 11, in operation 1101, UE may scan a plurality of secondary nodes SNs where radio signals are measured around the UE.

In operation 1103, the UE may transmit a scanning result to a master node MN. According to the exemplary embodiment, operation 1103 of transmitting the scanning result may include periodically reporting the scanning result or transmitting the scanning result when requested by the MN.

In operation 1105, the UE may receive information about an SN group from the MN.

Operations 1101, 1103, and 1105 correspond to operation 311 of FIG. 3, and may correspond to operations 411 to 423 of FIG. 4. The detailed descriptions of the operations are illustrated in operation 311 of FIG. 3 and operations 411 to 423 of FIG. 4.

In operation 1107, the UE may connect to an active SN on the basis of the information about the SN group. According to the exemplary embodiment, a process of connecting to the active SN may be performed according to a random access procedure.

Operation 1107 corresponds to operation 313 of FIG. 3, and may correspond to operation 425 of FIG. 4. The detailed description of the operation is illustrated in operation 313 of FIG. 3 and operation 425 of FIG. 4.

In operation 1109, the UE 401 may transmit a message for establishing and modifying a PDU session to the CN. According to the exemplary embodiment, the message for establishing and modifying the PDU session may include information about a multi-radio multi-connectivity (MR-MC) indicator, SN identifiers, an MN identifier, an SN group identifier, SN group information, and an SN-CN deployment type. According to the exemplary embodiment, when the SN-CN deployment type is SN-CN UP with CP, an N3 tunnel for data transmission between the UPF and the active SN may be created. According to another exemplary embodiment, the message for establishing and modifying the PDU session may include an active SN change indicator, a serving SN identifier, a target SN identifier, an MN identifier, and SN group identifier information. Operation 1109 may correspond to operation 315 of FIG. 3, and may correspond to operations 427 to 431 of FIG. 4. The detailed description of the operation is illustrated in operation 315 of FIG. 3 and operations 427 to 431 of FIG. 4.

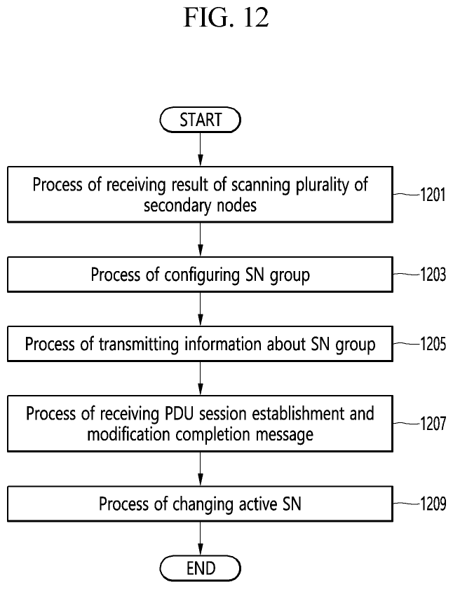

FIG. 12 a view illustrating a method of operating a master node in the wireless communication system according to the exemplary embodiments of the present disclosure.

Referring to FIG. 12, in operation 1201, a MN may receive a result of scanning a plurality of secondary nodes SNs from user equipment (UE).

In operation 1203, the MN may configure an SN group on the basis of the scanning result. According to the exemplary embodiment, information on the SN group may include an SN group identifier and a list of identifiers constituting the SN group.

In operation 1205, the MN may transmit the information about the SN group to the UE.

Operations 1201, 1203, and 1205 correspond to operation 311 of FIG. 3, and may correspond to operations 411 to 423 of FIG. 4. The detailed descriptions of the operations are shown in operation 311 of FIG. 3 and operations 411 to 423 of FIG. 4.

In operation 1207, the MN may receive a message for notifying completion of establishing and modifying a PDU session from a core network CN. Operation 1207 may correspond to operation 315 of FIG. 3, and may correspond to operations 427 to 435 of FIG. 4. The detailed description of the operation is illustrated in operation 315 of FIG. 3 and operations 427 to 435 of FIG. 4.

In operation 1209, the MN may change an active SN on the basis of the message of operation 1207. According to the exemplary embodiment, a process of transmitting an RRC Reconfiguration message to the UE may be included, and RRC Reconfiguration message may include an active SN change indicator and a T-SN identifier.

According to another exemplary embodiment, in the process of changing the active SN, when receiving RRC Reconfiguration completion from the UE, the MN may transmit an SN Reconfiguration message to a target SN. The SN Reconfiguration message may include an active SN change indicator and serving SN information. The serving SN information may include a PDU session identifier, a serving SN identifier, serving access node (AN) tunnel information, and serving CN tunnel information. Operation 1109 may correspond to operation 319 of FIG. 3 and operations 511 to 529 of FIG. 5. The detailed description of the operation is illustrated in operation 317 of FIG. 3 and operations 511 to 529 of FIG. 4.

According to the exemplary embodiment, the MN may change a SN group. The process of changing the SN group may include a process of transmitting an SN deletion request message to the active SN. The SN deletion request message may include an SN group identifier, a PDU session identifier, a UPF address, and N3 tunnel information.

According to another exemplary embodiment, when receiving RRC Reconfiguration completion from UE, an MN may transmit an SN Reconfiguration message to a target SN. The SN Reconfiguration message may include an active SN change indicator and serving SN information. The serving SN information may include a PDU session identifier, a serving SN identifier, serving access node (AN) tunnel information, and serving CN tunnel information.

According to a yet another exemplary embodiment, an MN may change an SN group. The process of changing the SN group may include a process of transmitting an SN deletion request message to the active SN. The SN deletion request message may include an SN group identifier, a PDU session identifier, a UPF address, and N3 tunnel information.

According to a yet another exemplary embodiment, changing of a SN group may include: changing, by an MN, SN group information when the MN receives an SN deletion request ACK (acknowledgment) in response to an SN deletion request message; and transmitting forwarding address information to the SN.

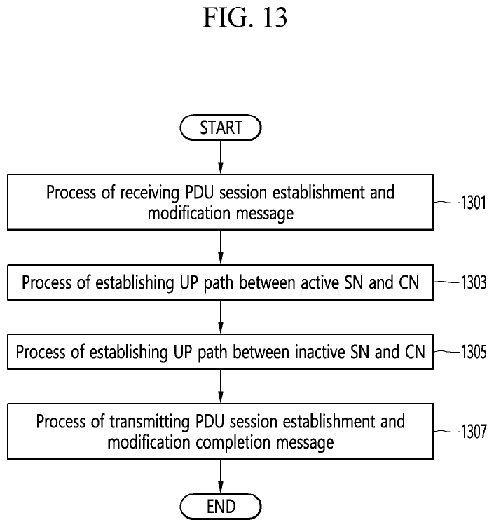

FIG. 13 a view illustrating a method of operating a core network in the wireless communication system according to the exemplary embodiments of the present disclosure.

Referring to FIG. 13, in operation 1301, a CN may receive a message for establishing and modifying a PDU session from user equipment (UE). Operation 1301 may correspond to operation 315 of FIG. 3, and may correspond to operations 427 to 435 of FIG. 4. The detailed description of the operation is illustrated in operation 315 of FIG. 3 and operations 427 to 435 of FIG. 4.

In operation 1303, the CN may establish a user plane (UP) path between an active secondary node (SN) and the CN on the basis of the message of operation 1301.

In operation 1305, the CN may establish the user plane (UP) path between an inactive secondary node (SN) and the CN on the basis of the message of operation 1301.

In operation 1307, the CN may transmit a message for notifying the UE of completion of establishing and modifying the PDU session.

Operations 1303 to 1307 may correspond to operations 315 to 317 of FIG. 3, and may correspond to operations 427 to 435 of FIG. 4. The detailed description of the operation is illustrated in operations 315 to 317 of FIG. 3 and operations 427 to 435 of FIG. 4.

According to the exemplary embodiment, the CN may distribute information about the SN group to a session management function (SMF) and a user plane function (UPF). The information on the SN group is managed for each PDU session, and the information on the SN group may include a PDU session identifier, an MN identifier, an active SN identifier, an SN group identifier, and an SN group list.

According to the exemplary embodiment, the CN may receive a message for notifying the change of SN group members from the MN. The message for notifying the change of the SN group members may include a PDU session identifier, an SN group modification indicator, and changed SN group information. The SN group modification indicator may include information notifying the CN that the configuration of the SN group is modified.

As described above, the present disclosure relates to a mobile communication system, wherein, in 3GPP mobile communication system of which the MR-MC environment uses sub-THZ bands that have narrow coverage and unstable wireless transmission characteristics for secondary nodes, high-capacity multimedia services requiring low latency is provided and high-density access nodes are supported when user mobility is to be ensured as well.

According to the present disclosure, the access nodes and the core network collectively manage the plurality of secondary nodes to which the user is able to connect, and the data paths between the core network and inactive access nodes may be established in advance in consideration of the user's movement.

In addition, in the procedure for control signals between the access nodes or control signals to and from the core network, the present disclosure may reduce the latency due to frequent changes of the active SNs when the user moves. For example, in a system requiring frequent secondary node changes depending on user's movement paths, such as vehicle-to-everything (V2X), large-capacity multimedia services that require low latency may be provided and user mobility may be ensured.

In the present specification, a terminal may be referred to as “user equipment (UE)”, a “mobile station”, a “subscriber station”, a “remote terminal”, a “wireless terminal”, a “user device”, or other terms having an equivalent technical meaning.

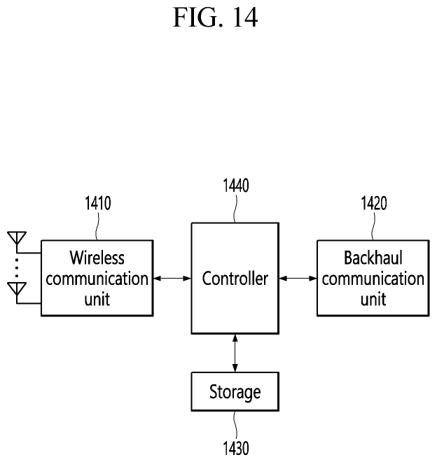

FIG. 14 is a view illustrating a configuration of an access node in the wireless communication system according to various exemplary embodiments of the present disclosure. Hereinafter, the terms used below, such as “˜part” and “˜group” mean a unit for processing at least one function or operation and may be implemented by a combination of hardware and/or software.

Referring to FIG. 14, an access node includes a wireless communication unit 1410, a backhaul communication unit 1420, a storage 1430, and a controller 1440.

The wireless communication unit 1410 performs functions for transmitting and receiving signals through a wireless channel. For example, the wireless communication unit 1410 performs a conversion function between a baseband signal and a bit stream according to physical layer standards of a system. For example, when transmitting data, the wireless communication unit 1410 creates complex symbols by encoding and modulating a transmission bit stream. In addition, when receiving data, the wireless communication unit 1410 restores a reception bit stream by demodulating and decoding the baseband signal.

In addition, the wireless communication unit 1410 upconverts the baseband signal into a radio frequency (RF) band signal and then transmits the RF band signal through an antenna, and downconverts the RF band signal received through the antenna into a baseband signal. To this end, the wireless communication unit 1410 may include a transmission filter, a reception filter, an amplifier, a mixer, an oscillator, a digital to analog converter (DAC), an analog to digital converter (ADC), and the like. In addition, the wireless communication unit 1410 may include a plurality of transmission/reception paths. Furthermore, the wireless communication unit 1410 may include at least one antenna array composed of a plurality of antenna elements.

In terms of hardware, the wireless communication unit 1410 may be composed of a digital unit and an analog unit, and the analog unit may be composed of a plurality of sub-units according to operation power, operation frequencies, etc. The digital unit may be implemented with at least one processor (e.g., a digital signal processor (DSP)).

The wireless communication unit 1410 transmits and receives signals as described above. Accordingly, all or part of the wireless communication unit 1410 may be referred to as a “transmitter”, a “receiver”, or a “transceiver”. In addition, in the following description, transmission and reception, which are performed through the wireless channel, are used in the meaning, including that the above-described processing is performed by the wireless communication unit 1410.

The backhaul communication unit 1420 provides an interface for communicating with other nodes in a network. That is, the backhaul communication unit 1420 converts a bit stream transmitted to another node in access, for example, another access node, another base station, an upper node, a core network, etc., into a physical signal, and converts the physical signal received from another node into the bit stream.

The storage 1430 stores data such as a basic program, an application program, and setting information, which are for node operations. The storage 1430 may be composed of a volatile memory, a non-volatile memory, or a combination of the volatile and non-volatile memories. In addition, the storage 1430 provides the stored data according to a request of the controller 1440.

The controller 1440 controls overall operations of nodes. For example, the controller 1440 transmits and receives signals through the wireless communication unit 1410 or the backhaul communication unit 1420. In addition, the controller 1440 writes and reads data to and from the storage 1430. In addition, the controller 1440 may perform protocol stack functions required by communication standards. According to another exemplary embodiment, a protocol stack may be included in the wireless communication unit 1410. To this end, the controller 1440 may include at least one processor. According to various exemplary embodiments, the controller 1440 may control the nodes (e.g., the master node and secondary nodes) to perform operations according to various exemplary embodiments described later.

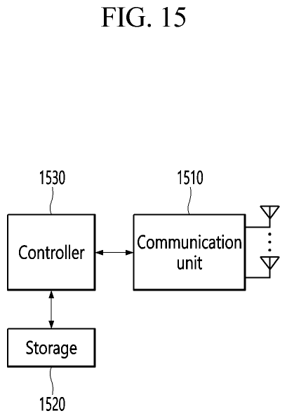

FIG. 15 is the view illustrating the configuration of a terminal in the wireless communication system according to various exemplary embodiments of the present disclosure. Hereinafter, the terms used below, such as “˜part” and “˜group” mean a unit for processing at least one function or operation and may be implemented by hardware or software, or a combination of hardware and/or software.

Referring to FIG. 15, a terminal includes a communication unit 1510, a storage 1520, and a controller 1530.

The communication unit 1510 performs functions for transmitting and receiving signals through a wireless channel. For example, the communication unit 1510 performs a conversion function between a baseband signal and a bit stream according to physical layer standards of a system. For example, when transmitting data, the communication unit 1510 creates complex symbols by encoding and modulating a transmission bit stream. In addition, when receiving data, the communication unit 1510 restores a reception bit stream by demodulating and decoding the baseband signal. In addition, the wireless communication unit 1510 upconverts a baseband signal into a RF band signal before transmitting the RF band signal through an antenna, and downconverts the RF band signal received through the antenna into a baseband signal. For example, the communication unit 1510 may include a transmission filter, a reception filter, an amplifier, a mixer, an oscillator, a DAC, an ADC, etc.

In addition, the communication unit 1510 may include a plurality of transmission/reception paths. Furthermore, the communication unit 1510 may include at least one antenna array composed of a plurality of antenna elements. In terms of hardware, the communication unit 1510 may include a digital circuit and an analog circuit (e.g., a radio frequency integrated circuit (RFIC)). Here, the digital circuit and the analog circuit may be implemented in one package. In addition, the communication unit 1510 may include multiple RF chains. Furthermore, the communication unit 1510 may perform beamforming.

The communication unit 1510 transmits and receives signals as described above. Accordingly, all or part of the communication unit 1510 may be referred to as a “transmitter”, a “receiver”, or a “transceiver”. In addition, in the following description, transmission and reception, which are performed through a wireless channel, are used in the meaning, including that the above-described processing is performed by the wireless communication unit 1510.

The storage 1520 stores data such as a basic program, an application program, and setting information, which are for terminal operation. The storage 1520 may be composed of a volatile memory, a non-volatile memory, or a combination of the volatile and non-volatile memories. In addition, the storage 1520 provides the stored data according to a request of the controller 1530.

The controller 1530 controls overall operations of the terminals. For example, the controller 1530 transmits and receives signals through the communication unit 1510. In addition, the controller 1530 writes and reads data to and from the storage 1520. In addition, the controller 1530 may perform protocol stack functions required by communication standards. To this end, the controller 1530 may include at least one processor or microprocessor, or may be a part of the processor. In addition, a part of the communication unit 1510 and the controller 1530 may be referred to as a communication processor (CP).

According to various exemplary embodiments, the controller 1530 may control the terminal to perform operations according to various exemplary embodiments described below.

The methods according to the exemplary embodiments described in the claims or specification of the present disclosure may be implemented in the form of hardware, software, or a combination of hardware and/or software.

When implemented in software, a computer readable storage medium for storing one or more programs (i.e., software modules) may be provided. One or more programs stored in the computer-readable storage medium are configured for execution by one or more processors in an electronic device. One or more programs include instructions that cause the electronic device to execute the methods according to the exemplary embodiments described in the claims or specification of the present disclosure.

Such programs (i.e., software modules, software) may be stored in a random access memory, a non-volatile memory including a flash memory, a read only memory (ROM), an electrically erasable programmable read only memory (EEPROM), a magnetic disc storage device, a compact disc-ROM (CD-ROM), a digital versatile discs (DVDs) or other forms of optical storage devices, or a magnetic cassette. Alternatively, such programs may be stored in a memory composed of a combination of some or all thereof. In addition, a plurality of configuration memories may be included.

In addition, the programs may be stored in an attachable storage device that can be accessed through a communication network such as the Internet, an intranet, a local area network (LAN), a wide area network (WAN), or a storage area network (SAN), or through a communication network composed of a combination thereof. Such a storage device may be connected to a device for performing the exemplary embodiments of the present disclosure through an external port. In addition, a separate storage device on the communication network may be connected to a device for performing the exemplary embodiments of the present disclosure.

In the specific exemplary embodiments of the present disclosure described above, the components included in the disclosure are expressed in singular or plural numbers according to the specific exemplary embodiments presented. However, the singular or plural expressions are selected appropriately for the presented situation for convenience of description, and the present disclosure is not limited to the singular or plural components. Even components expressed in plural may be composed of a single component, or even a component expressed in a singular number may be composed of a plurality of components.

Meanwhile, in the detailed description of the present disclosure, specific exemplary embodiments have been described, but various modifications may be made without departing from the scope of the present disclosure. Therefore, the scope of the present disclosure should not be limited to the exemplary embodiments described above, but should be defined not only by the scope of claims described later, but also by those equivalent to the scope of these claims.

What is claimed is:

1. A method performed by user equipment (UE) in a wireless communication system, the method comprising:
scanning a plurality of secondary nodes (SNs) where radio signals are measured around the UE;
transmitting a scanning result to a master node (MN);
receiving information about an SN group generated based on the scanning from the MN;
accessing an active SN on the basis of the information about the SN group; and
transmitting a message for establishing and modifying a protocol data unit (PDU) session to a core network (CN).

2. The method of claim 1, wherein the transmitting the scanning result comprises:
reporting periodically the scanning result or transmitting the scanning result when requested by the MN.

3. The method of claim 1, wherein the accessing the active SN is performed according to a random access procedure.

4. The method of claim 1, wherein the message for establishing and modifying the PDU session comprises information about a multi-radio multi-connectivity (MR-MC) indicator, SN identifiers, an MN identifier, an SN group identifier, the SN group information, and an SN-CN deployment type.

5. The method of claim 4, wherein an N3 tunnel for data transmission between a UPF and the active SN is created when the SN-CN deployment type is SN-CN UP with CP.

6. The method of claim 1, wherein the message for establishing and modifying the PDU session comprises an active SN change indicator, a serving SN identifier, a target SN identifier, an MN identifier, and SN group identifier information.

7. A method performed by a master node (MN) in a wireless communication system, the method comprising:
receiving a scanning result for a plurality of secondary nodes (SNs) from user equipment (UE);
configuring an SN group on the basis of the scanning result;
transmitting information about the SN group to the UE;
receiving a message for notifying completion of establishing and modifying a PDU session from a core network (CN); and
changing an active SN on the basis of the message.

8. The method of claim 7, wherein the SN group is assigned with an SN group identifier.

9. The method of claim 7, wherein the information on the SN group comprises an SN group identifier and a list of identifiers constituting the SN group.

10. The method of claim 7, wherein the changing the active SN comprises transmitting an RRC Reconfiguration message to the UE, and
the RRC Reconfiguration message comprises an active SN change indicator and a T-SN identifier.

11. The method of claim 7, wherein the changing the active SN comprise transmitting an SN Reconfiguration message to the target SN when the MN receives RRC Reconfiguration completion from the UE,
the SN Reconfiguration message comprises the active SN change indicator and serving SN information, and
the serving SN information comprises a PDU session identifier, a serving SN identifier, serving access node (AN) tunnel information, and serving CN tunnel information.

12. The method of claim 7, further comprising:
changing the SN group,
wherein the changing the SN group comprises transmitting an SN deletion request message to the active SN.

13. The method of claim 12, wherein the SN deletion request message comprises an SN group identifier, a PDU session identifier, a UPF address, and N3 tunnel information.

14. The method of claim 12, wherein, when the MN receives an SN deletion request ACK (acknowledgment) in response to the SN deletion request message, the changing the SN group comprises:
modifying, by the MN, the SN group information; and
transmitting, by the MN, forwarding address information to the SN.

15. A method performed by a core network (CN) in a wireless communication system, the method comprising:
receiving a message for establishing and modifying a PDU session from user equipment (UE);
establishing a user plane (UP) path between an active secondary node (SN) and the CN on the basis of the message;
establishing a user plane (UP) path between an inactive secondary node (SN) and the CN on the basis of the message; and
transmitting a message for notifying the UE of completion of establishing and modifying the PDU session.

16. The method of claim 15, further comprising:
distributing information about an SN group to a session management function (SMF) and a user plane function (UPF).

17. The method of claim 16, wherein the information on the SN group is managed for each PDU session, and
the information on the SN group comprises a PDU session identifier, an MN identifier, an active SN identifier, an SN group identifier, and an SN group list.

18. The method of claim 16, further comprising:
receiving a message for notifying a change of SN group members from an MN.

19. The method of claim 18, wherein the message for notifying the change of the SN group members comprises a PDU session identifier, an SN group modification indicator, and modified SN group information.

20. The method of claim 19, wherein the SN group modification indicator comprises information notifying the CN that a configuration of the SN group is modified.
